(19) United States
(12) Patent Application Publication
(10) Pub. No.: US 2006/0198915 A1
(43) Pub. Date: Sep. 7, 2006

(54) Method and device for quality assurance of crimp joints

(75) Inventor: Erhard Anton, Marxzell (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Schaefer Werkzeug- und Sondermaschinen GmbH, Bad Schoenborn-La (DE)

(21) Appl. No.: 11/416,022

(22) Filed: May 1, 2006

Related U.S. Application Data
(62) Division of application No. 10/621,553, filed on Jul. 17, 2003.

(30) Foreign Application Priority Data
Jul. 17, 2002 (DE) 102 32 470.0-34

(51) Int. Cl. B29C 35/08

(52) U.S. Cl. 425/150; 425/391

(57) ABSTRACT

A method for the quality assurance of crimp joints on crimping devices, in which, based on a setpoint dimension of crimp force and/or crimp height, the actual value of crimp force and/or crimp height is measured continuously within defined upper and/or lower tolerance dimensions of crimp force and/or crimp height, and a corrected re-adjustment of crimp height is effected after the actual values have reach a correction value.

Priority is claimed to German Patent Application DE 102 32 470.0-34, filed on Jul. 17, 2002, the subject matter of which is incorporated by reference herein.

### BACKGROUND

The present invention relates to a method and a device for the quality assurance of crimp joints on crimping devices.

Quality assurance is of great importance in series manufacture of crimp joints. The electric wire must be tightly enclosed by the electric terminal in order to guarantee good current transfer and also to prevent cavities that can lead to corrosion. The closing height of the tool in relation to the thickness of the electric wire is especially important in this process. If the closing height is too high, then the joint can have excessively low tensile strength. If the closing height is too low, then this can cause the strands to break off and in this case also result in excessively low tensile strength. The setting of correct crimp height is therefore an important issue in connection with crimping devices.

In German Patent Application DE 43 37 796A1, a method for monitoring the quality of crimp joints is specified in which the force curves over time for a plurality of reference measurements are recorded as measured curves, and an averaged measured curve is formed, to which an upper and a lower curve, each some distance away, are applied so that a tolerance band results. When a crimping process is being monitored, the measured curve that is determined from this crimping process is checked to see whether it lies completely within the area of the tolerance band. Faulty crimping processes can be determined in this way.

In German Patent Application DE 198 43 156A1, a method is described in which measured data that is obtained from a force-displacement characteristic measured during the crimping process is compared with stored setpoint data. If the force-displacement characteristic deviates from the setpoint curve, a fault is indicated. In this method, the force-displacement characteristic of the tool parts is recorded for each tool during the crimping process and stored as the setpoint characteristic of the crimping device. When this tool is again used, an initial crimping process is carried out, and then it is possible to determine immediately whether this crimping process agrees with the setpoint data or not. The force-displacement curve is used for this purpose.

German Patent Application DE 691 24 421 T2 disclosed a method or a device for adjusting crimp height in which the crimp height is automatically adjusted as a function of the crimp force. The crimp force that occurs during a crimping process is compared with optimum values, and when there are deviations from those values, precision adjustment of crimp height is effected.

All methods cited above relate to individual crimping processes and their quality assurance. When there is a faulty crimping process, the affected part is indicated as faulty and sorted out. Not considered are long-term processes in which an overall deterioration in quality can occur without being detected in individual crimping processes. This is the case, for example, if the crimping device is put into operation again after having been idle.

### SUMMARY OF THE INVENTION

An object of the present invention is to provide a method for the quality assurance of crimp joints by which it is also possible to measure and record long-term processes reliably.

The present invention provides a method for the quality assurance of crimp joints on crimping devices, wherein, based on a setpoint dimension (X) of a crimp parameter (i.e. a crimp force and/or crimp height (H)), the actual value (I) of the crimp force and/or crimp height (H) is measured continuously within defined upper and/or lower tolerance dimensions (X1, X2) of crimp force and/or crimp height (H), and a corrected re-adjustment of crimp height (H) is effected after the actual values (I) have reached a correction value (Y).

The present invention also provides a device for carrying out the aforesaid method that includes a movable die part that is moved back and forth by a driving connecting rod, a stationary die part, and a mechanism for press height adjustment. The driving connecting rod (11) is provided with a sliding die part (10) that slides along the rod in its longitudinal direction and with a positioning drive (14) for precision adjustment of the press height (H). The positioning drive (14) is controlled by a comparative setpoint/actual-value regulating system (15).

Based on a determined setpoint dimension of crimp force and/or crimp height for a specific tool, the actual value of crimp force and/or crimp height during the crimping processes is measured continuously within defined upper and/or lower tolerance dimensions of crimp force and/or crimp height, and a corrected re-adjustment of crimp height is carried out after a plurality of measured actual values has reached a correction measured value. When a crimping device is started up, the machine temperature is approximately constant at the start of production. The device heats up over time, however, and the machine body expands, which results in an increase in crimp height and, at the same time, a reduction in crimp force. Over time, this leads to a situation in which a deviation from the crimp height setpoint value occurs. As soon as this deviation reaches a calculated correction dimension, which is still clearly within the upper tolerance dimensions of crimp height and/or the lower tolerance limit of crimp force, a corrected re-adjustment of crimp height is effected. This is carried out by appropriate mechanisms on the crimping device.

A correction dimension that is preferably approximately half of a tolerance dimension is defined as the correction measured value. This correction measured value is at the same time the mean value of the measured actual values of the individual crimping processes.

During the crimping device's heatup phase, a plurality of corrected re-adjustments of crimp height normally take place. This is carried out until the crimping device has reached its temperature stability and the setpoint value of crimp height is maintained within a defined minimum range.

The device for carrying out the method is provided with a movable die part that is moved back and forth by a driving connecting rod and a stationary die part that includes a mechanism for press height adjustment. The device is distinguished by the fact that the driving connecting rod is provided with a sliding die part that slides along the rod in its longitudinal direction and with a displacement-causing positioning drive for precision adjustment of the press height, the positioning drive being controlled by a comparative setpoint/actual-value regulating system.

The actual value of the regulating system is picked up by an actual-value sensor mounted on the positioning drive. The setpoint value may be set on the device's operator control unit or be defined by a calculated reference quantity from the crimp force measurement. The setpoint value of the regulating system is then determined by the force curve during the crimping process.

For the setpoint/actual-value regulating system, a comparator is provided in which the setpoint value from the operator control unit or from the crimp force curve during the crimping process is stored.

The positioning drive conveniently includes a stepping motor and a gear unit. The positioning member itself is an eccentric pin that is inserted into a hole in the driving connecting rod at right angles to the rod's direction of movement. The axis of rotation of the eccentric pin is connected to the actual-value sensor, which transmits the position value of the eccentric pin to the comparator. The positioning accuracy of the eccentric pin is 0.002 mm.

The actual value of the crimp force curve is measured during the entire crimping process and compared with the setpoint value of the crimp force curve as defined in the comparator. When there are deviations between the actual value and the setpoint value, the crimp force curve is corrected in the direction of the setpoint value by changing the press height.

### BRIEF DESCRIPTION OF THE DRAWINGS

The invention is explained in greater detail below with reference to an exemplary embodiment shown in the drawings, in which:

FIG. 1 shows a schematic diagram of the production run with regulation by the press height precision adjustment feature; and

FIG. 2 shows the device with a mechanism for precision adjustment of press height.

### DETAILED DESCRIPTION

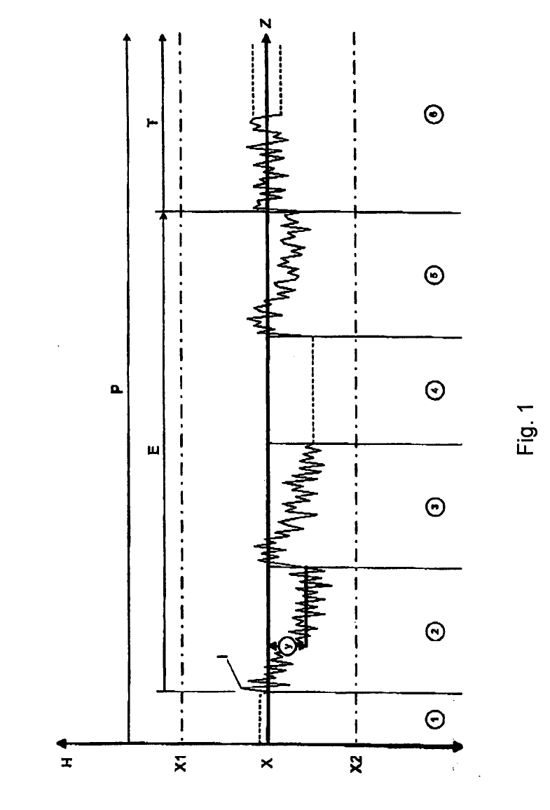

FIG. 1 shows a schematic diagram of the method as it takes place during a production run. X designates the setpoint dimension for crimp height H. On time axis Z, this is a straight line. X1 designates the lower tolerance dimension of crimp height H, and X2 designates the upper tolerance dimension of crimp height H. No objections may be raised regarding the quality of crimp joints manufactured within these tolerance dimensions, X1 and X2. The production run is subdivided into phases 1 through 6. In phase 1 after the crimping device is started up, the device temperature is approximately constant. The actual values of crimp height H are not shown in detail here and move within a narrow tolerance band around setpoint dimension X. In phase 2, initial heating takes place and consequently expansion of the device body as well, which leads to an increase in crimp height H. Actual values I of the individual crimping processes show a downward trend in the diagram, i.e., in the direction of a higher crimp height H or lower crimp force. When these actual values I reach defined correction value Y, re-adjustment of crimp height H takes place through reduction of crimp height H, i.e., the individual crimping processes are brought again to the level of setpoint dimension X. Correction measured value Y is a mean value of a plurality of measured actual values I. This correction measured value Y amounts to approximately half of a tolerance dimension, such as tolerance dimension X2 in this case. This process for phase 2 may be repeated a number of times, namely until the crimping device has reached its operating temperature and process stability has been established, as shown in the drawing during phase 6. Heatup E of the crimping device includes phases 2 through 5 in the present exemplary embodiment. In phase 6, temperature stability T has been established. Entire production run P consequently includes phase 1, which involves approximately constant crimping device temperature, phases 2 through 5; or range E, in which heatup of the crimping device takes place, and phase 6, in which the crimping device has reached its operating temperature T and therefore its process stability.

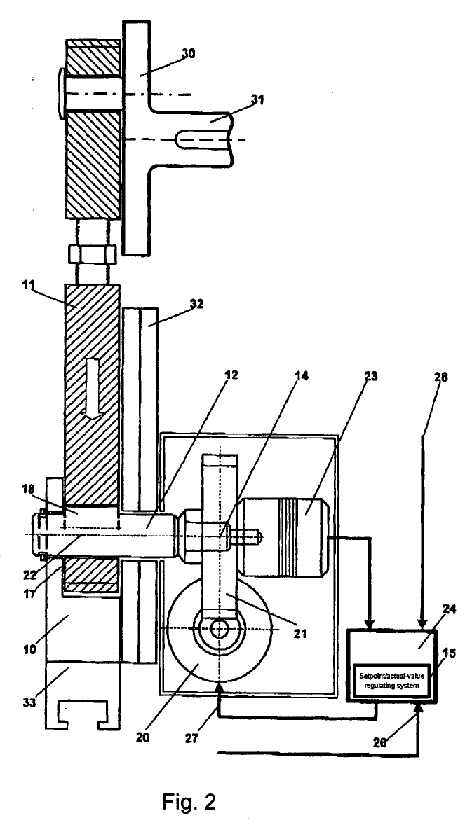

FIG. 2 shows the mechanism for press height adjustment, as it is used on a device for carrying out the method. The mechanism essentially includes driving connecting rod 11, die part 10, positioning drive 14 and comparative setpoint/actual-value regulating system 15. Driving connecting rod 11 is driven by eccentric 30. The eccentric itself is driven by shaft 31. Die part 10 is held in guide 32 and is movable in its longitudinal direction. Toolholder 33 is mounted on die part 10. The second tool part located below it is not shown. Press height H is the distance between these two tool parts when the tool is open. Driving connecting rod 11 contains hole 17 in which positioning member 12 is installed. At the same time, positioning member 12 forms the connection between driving connecting rod 11 and die part 10. In the area of hole 17 of driving connecting rod 11, positioning member 12 is designed as an eccentric pin 18. Positioning member 12 is connected to positioning drive 14, which is driven by stepping motor 20. Gear unit 21 is located in between. In addition, axis of rotation 22 of eccentric pin 18 is connected to an actual-value sensor 23, which transmits the position value of eccentric pin 18 to comparator 24. Setpoint value X of crimp height H is input into comparator 24 from the operator console via line 26.

Comparator 24 compares actual values I with setpoint value X and gives corresponding regulating signals to stepping motor 20 via line 27. At the same time, actual value I of the crimp force monitoring device is input into comparator 24 via line 28 so that the crimp force may also be used for regulating the mechanism.

1-4. (canceled)

5. A device for providing a crimp joint, comprising:
a movable die part;
a stationary die part;
a driving connecting rod for moving the moveable die part back and forth in a longitudinal direction, wherein a longitudinal position of the moveable die part with respect to the stationary die part is adjustable;
a positioning drive for adjusting the longitudinal position;
a comparative setpoint/actual value regulating system controlling the positioning drive; and
an actual value sensor disposed on the positioning drive for providing an actual value to the regulating system.

6. (canceled)

7. The device as recited in claim 5 further comprising an operator control unit for providing a setpoint value to the regulating system.

8. The device as recited in claim 7 wherein the setpoint value corresponds to a crimp force measurement.

9. The device as recited in claim 8 wherein the setpoint value is determined using a force curve during the crimping process.

10. The device as recited in claim 5 further comprising a comparator for storing the setpoint value for the setpoint/actual-value regulating system.

11. The device as recited in claim 5 wherein the positioning drive includes a stepping motor and a gear unit.

12. The device as recited in claims 5 wherein the driving connecting rod includes a hole perpendicular to the longitudinal direction and wherein the positioning drive includes a positioning member disposed in the hole.

13. The device as recited in claim 12 further comprising a comparator and an actual value sensor disposed on the positioning drive, wherein the positioning member includes an eccentric pin having an axis of rotation connected to the actual-value sensor, the actual value sensor transmitting a position value of the eccentric pin to the comparator.

14. The device as recited in claim 12 wherein the eccentric pin has a positioning accuracy of 0.002 mm.

15. The device as recited in claim 5, further comprising a comparator, wherein the actual value of a crimp force curve is measured during a crimping process and compared with a setpoint value defined in the comparator, the positioning drive adjusting the longitudinal position so as to correct the crimp force curve in a direction of the setpoint value when a deviation between the actual value and the setpoint value occurs.
